(19) United States
(12) Patent Application Publication
(10) Pub. No.: US 2026/0339734 A1
(43) Pub. Date: Oct. 29, 2026

(54) DATA CLOUD USAGE MANAGEMENT AND OPTIMIZATION

(71) Applicant: ServiceNow, Inc., Santa Clara, CA (US)

(72) Inventors: Ankit Agrawal, Hyderabad (IN); Rohan Tyagi, San Jose, CA (US)

(21) Appl. No.: 19/192,109

(22) Filed: Apr. 28, 2025

(51) Int. Cl. G06F 9/50

(52) U.S. Cl. CPC G06F 9/5033; G06F 9/5038; G06F 9/5044

(57) ABSTRACT

Aspects of the subject technology relate to systems, methods, and computer-readable media for processing usage data to correlate each group of an enterprise with respective computing resource usage. An example method can include obtaining usage data associated with a service. The method can further include generating a first group vector associated with the service and including a first group identifier and a first usage level associated with the first group identifier; and generating a second group vector associated with the service and including a second group identifier and a second usage level associated with the second group identifier. The example method includes determining, based on the usage data, the first and second group vectors, a resource allocation value that characterizes the respective usage of the service associated with the first group identifier and the second group identifier.

### BACKGROUND

### 1. Technical Field

The present disclosure generally relates to data management and more specifically, to processing usage data to allocate computing resource usage to the respective party within an organization.

### 2. Introduction

With advancements in technology, data has become one of the most valuable assets for organizations across industries. The surge in data generation and collection has led organizations to count on data management and solutions that can manage cloud spending in line with business needs. Specifically, organizations have implemented cloud usage management practice, which includes monitoring, analyzing, and optimizing cloud expenses to ensure efficient resource usage and cost control.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure.

FIG. 1B is a block diagram illustrating an example network architecture that can be used to implement one or more aspects, components, devices, nodes, systems, instances, and/or portions of the example cloud computing architecture, according to some examples of the present disclosure.

FIG. 2 is a diagram illustrating an example cloud usage management system, according to some examples of the present disclosure.

FIG. 3 is a diagram illustrating an example workflow of a cloud usage management system for allocating computing resource usage and optimizing the resource usage, according to some examples of the present disclosure.

FIG. 4 illustrates a flowchart of an example method of determining a resource allocation value characterizing respective usage of computing resources, according to some examples of the present disclosure.

FIG. 5 illustrates a flowchart of an example method of allocating computing resource usage to the respective group of an entity, according to some examples of the present disclosure.

FIG. 6 illustrates an example diagram of an interface of a cloud usage management system, according to some examples of the present disclosure.

FIG. 7 is an example of a deep learning neural network that can be used to implement all or a portion of the systems and techniques described herein, according to some examples of the present disclosure.

FIG. 8 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As previously described, with advancements in technology, data has become one of the most valuable assets for organizations across industries. The surge in data generation and collection has led organizations to count on data management and solutions that can manage cloud spending in line with business needs. Specifically, organizations have implemented cloud usage management (e.g., Cloud Cost Management (CCM)) practice, which includes monitoring, analyzing, and optimizing cloud expenses to ensure efficient resource usage and cost control.

However, cost allocation associated with data management platforms can be challenging and difficult. Unlike traditional IT expenses, data does not belong to a single entity within an organization. The value is realized when merged with other datasets to generate actional insights, making it difficult to attribute usage of the specific dataset to a single owner or consumer. For example, marketing data (e.g., funnel growth metrics) may be generated by a marketing team but utilized by both marketing and sales teams. It is difficult to determine whether the cost should be borne solely by the data owner, the consumer, or shared between both parties. As follows, the complexity of data ownership and consumption creates challenges in resource and resource usage allocation and cloud management.

The disclosed technology addresses the foregoing by, in some implementations, processing usage data to correlate each group with respective computing resource usage. Specifically, the disclosed technology can identify a portion of computing resource usage corresponding to a group of a plurality of groups within an entity based on usage information extracted from usage datasets, for example by analyzing queries. As follows, the disclosed technology can improve computing resource usage allocation and cloud data management by allocating the usage to appropriate stakeholder(s) associated with the data.

Furthermore, the disclosed technology can provide solutions for improving the efficiency of cloud management and computing resource usage by load balancing while minimizing spending and maximizing the return. The disclosed technology can identify cloud waste or inefficiencies and help organizations adjust the size of warehouses or use multi-cluster warehouses to scale up or down based on workload. Also, the disclosed technology can identify a suitable point of time for running a query in a database. For example, resource-intensive jobs can be scheduled to be performed during off-peak hours. As follows, not only can query performance be improved by reducing execution time but also computing resource usage can be optimized by consuming less amount of spend.

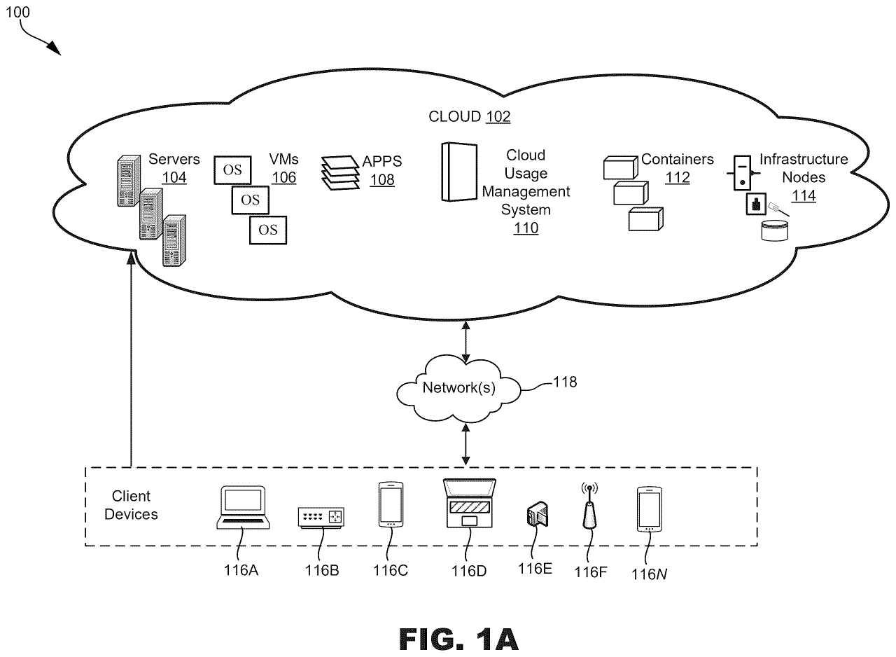

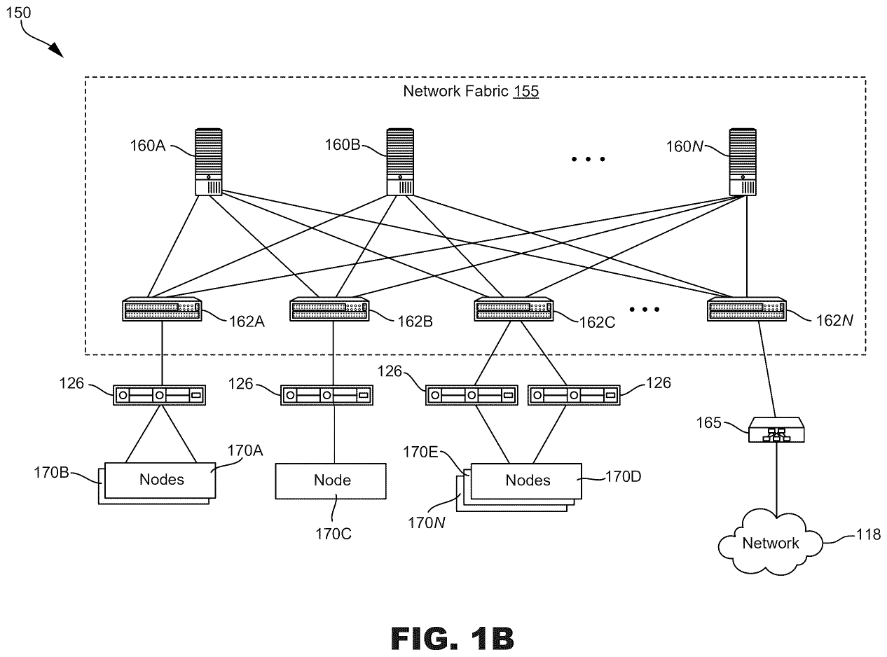

FIG. 1A illustrates a diagram of an example cloud computing environment 100 that can be used to implement a cloud usage management system, according to some examples of the present disclosure. The cloud computing environment 100 can include and/or represent a cloud 102. The cloud 102 can include one or more private clouds, public clouds, and/or hybrid clouds. Moreover, the cloud 102 can include cloud elements 104-114. The cloud elements 104-114 can include or represent, for example, servers 104, virtual machines (VMs) 106, applications or services 108, cloud usage management system 110, software containers 112, and/or infrastructure nodes 114. The infrastructure nodes 114 can include various types of nodes, such as compute nodes, storage nodes, network nodes, management systems, etc.

The cloud 102 can provide cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client devices 116A-N (collectively referred to as “client devices 116” hereinafter) can connect with the cloud 102 to obtain one or more specific services from the cloud 102. The client devices 116 can connect with the cloud 102 from any network of the client devices 116 such as a local area network (wired and/or wireless), a cellular network, and/or any other network, and using the network(s) 118 to transport communications between the cloud 102 and the client devices 116. For example, the client devices 116 can communicate with the cloud 102 and/or any of the elements 104-114 via a network(s) 118. The network(s) 118 can include one or more public networks (e.g., the Internet, a wide area network, etc.), one or more private networks (e.g., local area network(s), wireless local area network(s), private backbone network(s), etc.), and/or one or more hybrid networks (e.g., virtual private network(s), public and private cloud network(s), etc.).

The client devices 116 can include any device with networking capabilities, such as a laptop computer, a tablet computer, a server, a desktop computer, a smartphone, a network device (e.g., an access point, a router, a switch, etc.), a smart television, a smart car, a sensor system, a gaming console, a smart wearable device (e.g., smartwatch, etc.), an internet of things (IOT) device, a camera, a network printer, or any other computing device.

In some examples, the cloud 102 can implement cloud usage management system 110 associated with one or more entities. The client devices 116 can access the cloud usage management system 110 implemented and/or hosted in the cloud 102 for cloud usage management (e.g., allocation) and optimization, as further described herein. An example network architecture that can be used to implement a network or datacenter (or any portion thereof), such as the cloud 102, is shown in FIG. 1B and further described below. In some cases, one or more services, components, devices, nodes, systems, instances, and/or portions of the example network architecture 150 shown in FIG. 1B can be implemented by and/or in a cloud network or datacenter, such as the cloud 102.

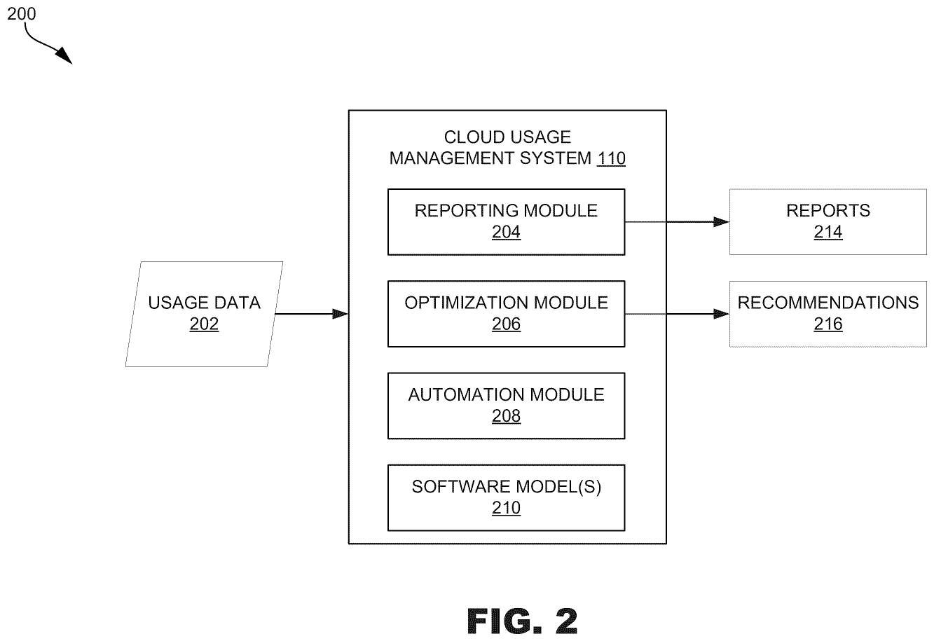

The cloud usage management system 110 is configured to track, monitor, and optimize the cloud resource usage and costs across various cloud environments (e.g., cloud computing environment 100). For example, cloud usage management system 110 may monitor and manage the usage of a database (for example, hosted and run on a cloud platform) that is implemented by an organization. The cloud usage management system 110 may obtain and analyze the usage data to understand how much data or resources have been used by the organization and allocate the resources and corresponding cost to a responsible party within the organization. Further details about the usage allocation and optimization are described below with respect to FIGS. 2-6.

FIG. 1B is a block diagram illustrating an example network architecture 150 that can be used to implement one or more portions of the example cloud computing environment 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run workloads/nodes. In some cases, a cloud node can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the node can host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, the cloud 102. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126, the network device 165, and/or the nodes 170A-N (collectively referred to as “nodes 170” hereinafter) with any portion of the network fabric 155 (e.g., including each other). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g., network 118, various network elements, the network device 165, the nodes 170, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. For example, the system servers 126 can implement any of the applications 108 and/or the cloud usage management system 110 hosted on the cloud 102. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170. In some examples, the nodes 170 can represent cloud instances. For example, in some cases, the nodes 170 can each represent a virtual server and/or environment (e.g., a VM, a software container, etc.) that uses compute, memory, storage, and/or networking resources on the cloud (e.g., network architecture 150) for respective workloads. For example, the nodes 170 can implement any of the applications 108 and/or the cloud usage management system 110 hosted on the cloud 102. In some implementations, the nodes 170 can perform parallel computing using, for example, multithreading. Each of the nodes 170 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 can represent a node instance that includes, implements, hosts, and/or runs a software container(s), an application(s), and/or an agentic escalation system(s). In some examples, a software container(s) associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, and/or the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

A cloud usage management system (e.g., a cloud cost management system) or an enterprise network associated with an entity can be implemented through the cloud computing environment 100 shown in FIG. 1A and the network architecture 150 shown in FIG. 1B. For example, user interfaces, data structures, and logic to implement the cloud usage management system 110 and perform cloud usage allocation and optimization can be implemented through the cloud computing environment 100 and/or the network architecture 150.

FIG. 2 is a diagram illustrating an example cloud usage management system 200, according to some examples of the present disclosure. In this example, cloud usage management system 110 can obtain, process, and analyze usage data 202, and generate reports 214 and/or recommendations 216. For example, cloud usage management system 110 can analyze the usage of compute resources (e.g., database, storage, etc.) and provide reports for usage and/or cost allocation, suggestions for optimizing the cloud consumption and costs, and so on.

The usage data 202 can include information about how cloud resources and services are being used in an organization. For example, usage data 202 can include information that tracks how cloud resources and services are used within an organization, for example and without limitation, compute resources usage, network usage, cost data, user and access activity, service usage, performance metrics, and so on. In some examples, usage data 202 can be obtained from an external system such as a data management software or platform provided by a CSP or via a third-party solution.

In some examples, usage data 202 may include additional data from a central database such as a Configuration Management Database (CMDB) associated with the organization. The CMDB data can provide information about mappings and relationships between different elements in the environment such as how it is configured, how everything is connected, who's responsible for it, etc., which can be used to correlate different components or services within the organization.

The cloud usage management system 110 can extract the usage information from usage data 202 to identify a usage pattern, a design architecture, wasted resources, a responsible party for the usage, etc. Specifically, cloud usage management system 110 can analyze queries that have been generated for the organization and correlate the resources used for each query to a specific business unit, product unit, or a responsible party for running each query. For example, cloud usage management system 110 can analyze queries associated with the organization to determine, per business unit/team of the organization, a total number or percentage of queries, total execution, total time, a number of failed queries, compile time, query complexity (e.g., high, moderate, low), query size (e.g., large, medium, small) and so on. Further, cloud usage management system 110 can, based on the query analysis, allocate costs and spending to a corresponding business unit or party within the organization.

In some cases, cloud usage management system 110 can analyze data tags associated with usage data 202. The data tags can include metadata attached to resources, data sets, or configuration items. For example, cloud usage management system 110 can identify or determine, based on data tags, ownership of objects, whether user running the queries has been automated with the right attribution of the compute resources consumed by the respective team, etc. The entire hierarchy can be structured, based on data tags, to identify the business unit and department level cost attribution. As follows, cloud usage management system 110 can determine or identify, based on data tags, which usage and/or cost belongs to which team within the organization.

In some implementations, cloud usage management system 110 may apply the pricing information and calculation method to come up with the total cost of utilizing the cloud or resources (e.g., determine a normalized cost for each user and business unit consuming the data). For example, cloud usage management system 110 can determine pricing attribution based on price catalog, which illustrates relationships between the compute resource usage and costs of the organization. The price attribution may be based on various factors of the compute resource usage such as a number of queries per business unit, total execution, execution time, a number of failed queries, query complexity, query size, and so on. In some cases, cloud usage management system 110 may consider any custom price sheet or discounts that are applicable to the organization to correctly come up with the total spend of utilizing the software by the organization.

In some cases, the cloud usage management system 110 may utilize additional metadata or contextual data to identify stakeholders associated with the data such as who ran the query or for whom the query was executed, map it with the Active Directory of the organization to detect department or various other methodologies to identify the potential payers of the cost of software use.

In some examples, cloud usage management system 110 may include reporting module 204, which is configured to generate reports 214 based on the analysis of usage data 202. Specifically, reports 214 can include an analysis of usage allocation or cost allocation. For example, reporting module 204 can generate reports 214 describing the analysis of queries per business unit and corresponding cost allocation for the resource usage per business unit within the organization.

In some implementations, cloud usage management system 110 may include optimization module 206, which is configured to generate, based on the analysis of usage data 202, recommendations 216 for an organization to better use compute resources, storage, and/or databases. For example, cloud usage management system 110 can identify inefficiencies in the use of the cloud, which lead to wasted spend and provide recommendations 216 on how to reduce the waste of resources and save costs.

The recommendations 216 can include various ways to optimize the usage of resources and costs, such as warehouse sizing, storage practices, query optimization, and so on. In some examples, optimization module 206 may correlate, based on the analysis of usage data 202, the usage of resources to a size of virtual warehouses and generate recommendations 216, which include using multi-cluster warehouses that can scale up or down based on workload, removing unnecessary duplicate warehouses, and managing the compute resources in the back end. For example, if a query requires a small-sized instance, but a larger-sized instance gets provisioned to run the query, optimization module 206 can identify such a case and suggest to a user to run the query on a smaller-sized instance.

In some cases, cloud usage management system 110 can leverage some of the cloud service providers' features such as auto-scaling to automatically adjust computing resources (e.g., CPU, memory, or compute cluster) based on the workload demand and auto-suspend to automatically pause or stop compute resources when they are idle (not being used).

Further, cloud usage management system 110 can use data compression to optimize the storage usage and reduce the storage costs. Specifically, optimization module 206 can identify a portion of data or datasets that are not frequently used and put it in a different place (e.g., lower-cost storage) or use data compression to reduce storage costs. For example, optimization module 206 can determine a frequency of access for each dataset (e.g., how often the dataset is accessed) and move (to a different storage) or remove the dataset that has a frequency lower than a threshold. As follows, optimization module 206 can provide recommendations 216, which may include regularly archiving or removing unnecessary historical data and/or utilizing a cloud service provider's tiered storage options to move less frequently accessed data to lower-cost storage. In some cases, optimization module 206 can recommend zero-copy cloning (e.g., creating a new metadata pointer to the existing data) without copying actual data rather than maintaining multiple versions of the same data.

Also, cloud usage management system 110 can optimize a query to reduce the consumption of resources. For example, optimization module 206 can rewrite a query such that the query can be run in a reduced time. In some cases, optimization module 206 can create appropriate indexes and use clustering keys, minimize data scanning by using efficient filtering, leverage materialized views for frequently run complex queries, and/or use query result caching to reduce redundant computations.

In some examples, recommendations 216 can include scheduling resource-intensive jobs to be run at a specific time (e.g., non-peak hours) to optimize performance and reduce costs. Specifically, optimization module 206 can suggest scheduling queries (e.g., heavy queries) during off-peak hours when compute costs may be lower or to avoid running during business hours to reduce impact. The optimization module 206 can, based on an analysis of usage data 202, identify a time window or range when a query can be run, which can also depend on a time zone or a size of resources needed to run the query. For example, recommendations 216 can include running a large warehouse aggregation at midnight instead of 1 μm.

In some cases, cloud usage management system 110 may include automation module 208, which is configured to automatically execute the recommendations 216 such that the change can happen in the cloud environment automatically without manual input form a user. In some examples, automations for recommendations 216 can be implemented as part of workflow(s).

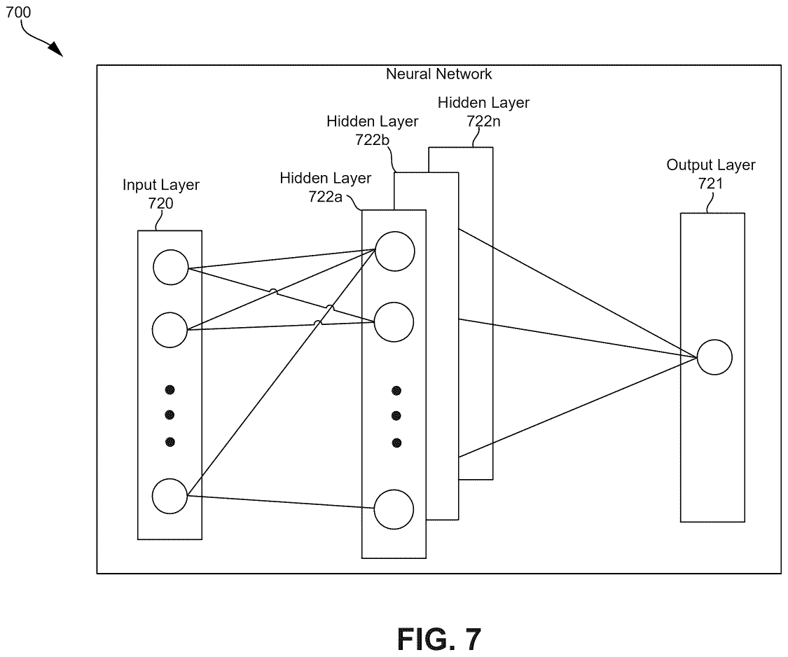

In some implementations, cloud usage management system 110 can include software model(s) 210 configured to receive usage data 202 and output reports 214 and/or recommendations 216. In some cases, software model(s) 210 can include one or more software algorithms. For example, software model(s) 210 can include one or more AI/ML models, such as LLM and implement a single AI/ML or multiple AI/ML models. In some examples, software model(s) 210 can implement one or more neural networks (e.g., deep learning neural network 700 as illustrated with respect to FIG. 7 below). Each of the one or more neural networks can include any neural network type/architecture such as, for example and without limitation, a transformer network, a convolutional neural network, an autoencoder network, a sequence-to-sequence network, a recurrent neural network, a long short-term memory network, a mixture-of-experts network, an encoder and/or decoder network (e.g., encoder-decoder network, encoder-only network, decoder-only network, etc.), and/or any other artificial and/or deep learning neural network.

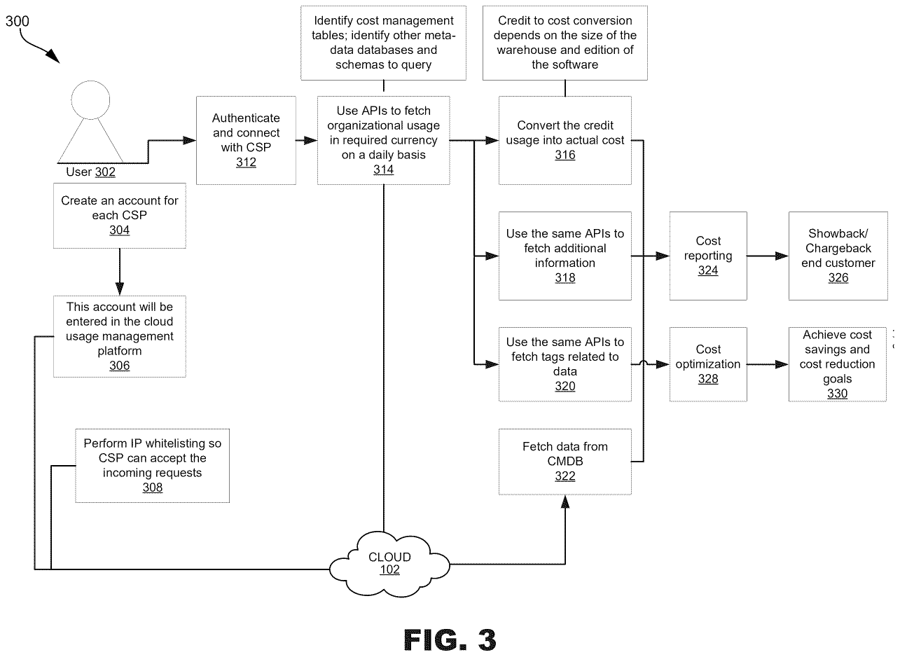

FIG. 3 is a diagram illustrating an example workflow 300 of a cloud usage management system for allocating computing resource usage and optimizing the resource usage, according to some examples of the present disclosure. In this example, cloud usage management system 110 is configured to monitor and analyze the usage of cloud (provided by a cloud service provider) by an organization (e.g., cloud resources used/utilized by an organization) and provide reports 214 and recommendations 216 for the organization to optimize the performance and costs.

At step 304, user 302 can (e.g., via client device 116 as illustrated in FIG. 1A), create an account for each cloud service provider (CSP) where a cloud-based data storage is hosted. This account can be entered into a cloud usage management platform at step 306. Also, IP whitelisting for this account can be performed such that the cloud usage management platform can accept the incoming requests at step 308.

At step 312, cloud usage management system 110 may authenticate the account associated with user 302 and connect with the database (or cloud) implemented by the organization. As step 314, cloud usage management system 110 may use APIs (e.g., Representational State Transfer (REST) APIs) to fetch usage data 202. In some examples, usage data 202 can include include organizational usage in required currency on a daily basis. From usage data 202, cloud usage management system 110 may identify cost management tables or identify other metadata databases and schemas to query.

In some examples, cloud usage management system 110 may convert the credit usage into actual cost at step 316 based on price catalog, or pricing information associated with the organization. For example, usage can be shown as 100 credits where each credit is equivalent to $2. As follows, the total cost would be $200. The credit-to-cost conversion may depend on the size of the warehouse and edition of the software.

At step 318, cloud usage management system 110 may fetch additional information (e.g., all databases, tables, and schemas) such as organizational information, automatic clustering history, serverless tasks, storage usage, data transfer, and so on. At step 320, cloud usage management system 110 may fetch data tags related to usage data 202 such as metadata attached to resources, data sets, or configuration items.

In some implementations, cloud usage management system 110 may fetch data from a CMDB via cloud 120 at step 322. Non-limiting examples of data that can be obtained from CMDB include application portfolio, owner teams, users, dependent services, etc. As follows, CMDB data can provide mapping and/or relationships (e.g., dependencies) between different components or elements, which can help identify stakeholders/responsible party for usage and cost allocation. In some cases, the same APIs (e.g., REST APIs) can be used for step 314, step 318, and/or step 320.

By processing various data obtained at step 314 through step 322, cloud usage management system 110 may perform cost reporting (e.g., generating reports 214) and/or cost optimization (e.g., generating recommendations 216). Specifically, at step 324, cloud usage management system 110 may generate reports 214 by allocating the cost to each business application, team, cost center, or any such parameter as per organization requirements. As follows, at step 326, showback and/or chargeback end-customer can be completed. For example, cloud usage management system 110 may send each team or responsible party a report describing how much compute/storage they have used (showback). Also, cloud usage management system 110 may transfer the cost from the IT budget to each team or responsible party's internal budget (chargeback).

The cost reporting can include top-down cost reporting and bottom-up cost reporting. Non-limiting examples of top-down cost reporting can include cost per application, cost per business unit, cost center, or department, cost of goods (COGS), cost anomaly detection, and cost to serve 1 user. Also, non-limiting examples of bottom-up cost reporting can include cost per query, cost per warehouse cluster, table, and cost of runaway query.

At step 326, cloud usage management system 110 may perform cost optimization by identifying usage patterns, query patterns, inefficient design architectures, wasted resources, etc. As previously illustrated, cost optimization can include deploying right-size warehouses, implementing efficient storage practices, optimization of query performance, workload management, and so on. As follows, at step 330, cost savings and cost reduction goals can be achieved.

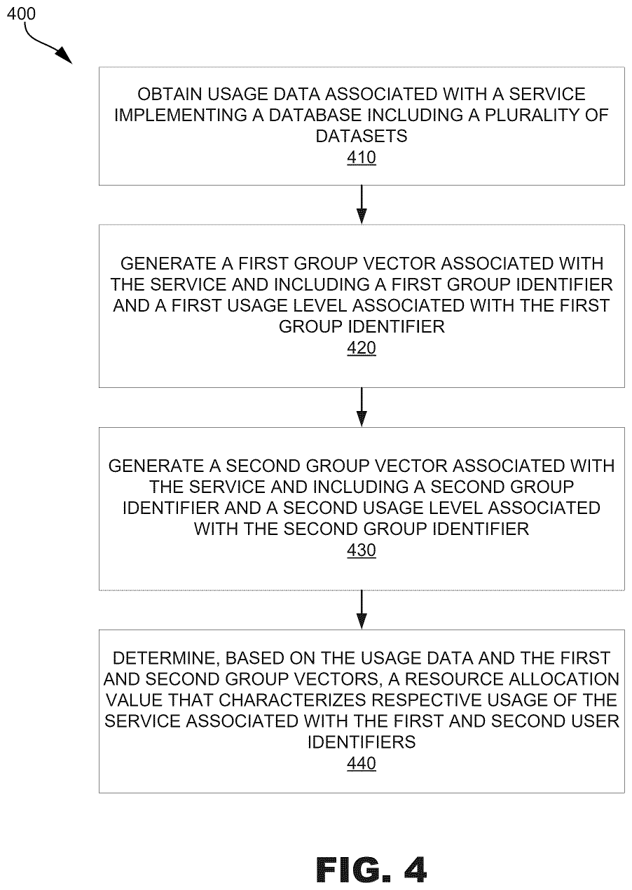

FIG. 4 illustrates a flowchart of an example method 400 for determining a resource allocation value characterizing respective usage of computing resources, according to some examples of the present disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIG. 2. However, method 400 is not limited to that example.

At step 410, method 400 includes obtaining usage data associated with a service. The service implements a database including a plurality of datasets. For example, cloud usage management system 110 may obtain usage data 202 associated with a service (e.g., an organization, an enterprise, etc.) that has implemented a database, which may be hosted and run on a cloud platform. As previously illustrated, usage data 202 can include information regarding the usage of the cloud or resources utilized by the service or the organization as a whole such as how cloud resources and services are being used in the organization.

At step 420, method 400 includes generating a first group vector associated with the service. The first group vector may include a first group identifier and a first usage level associated with the first group identifier. For example, cloud usage management system 110 can, based on usage data 202, generate a first group vector, which may include a first group identifier and a first usage level associated with the first group identifier. To illustrate one example, an organization may comprise a plurality of business teams such as a marketing team, a sales team, an engineering team, etc. The cloud usage management system 110 can create a group vector for a marketing team, which includes information about how much resource usage is consumed (e.g., a resource consumption level) by the marketing team based on usage data 202.

At step 430, method 400 includes generating a second group vector associated with the service. The second group vector may include a second group identifier and a second usage level associated with the second group identifier. For example, cloud usage management system 110 may create a group vector for a sales team, which may include information about how much resource usage is consumed by the sales team based on usage data 202. In some implementations, the first usage level indicates a first usage duration of the service by the first group identifier over a period of time, and the second usage level indicates a second usage duration of the service by the second group identifier over the period of time. A group identifier can be generated for any applicable number of groups that exist or have used the cloud resources within the organization.

At step 440, method 400 includes determining, based on the usage data, the first group vector, and the second group vector, a resource allocation value that characterizes respective usage of the service associated with the first group identifier and the second group identifier. For example, cloud usage management system 110 can, based on usage data 202, the first group vector (e.g., a marketing team vector), the second group vector (e.g., a sales team vector), a resource allocation value that represents the respective usage.

In some examples, method 400 includes allocating, to the first group identifier and the second group identifier, respective resources associated with the service based on the resource allocation value. For example, cloud usage management system 110 can correlate the resource usage to a responsible group such that respective resources can be allocated to each group identifier based on the resource allocation value. Further, based on the resource allocation, cloud usage management system 110 can allocate costs and/or spend to respective responsible groups within the organization based on the resource allocation value. This resource allocation and cost allocation can provide technical benefits such as helping organizations find ways to automatically identify stakeholders who are responsible for using the resources and sharing the cost of data management solutions. As follows, the resource usage management and performance can be improved by accurately identifying stakeholders and allocating the costs and spending accordingly.

Further, method 400 includes determining the first usage duration based on a number of queries associated with the first group identifier and determining the second usage duration based on a number of queries associated with the second group identifier. As previously illustrated, cloud usage management system 110 can analyze queries to determine the resource usage based on the queries associated with each of the groups within the organization. For example, cloud usage management system 110 can allocate the resource usage based on the analysis of various factors such as a number of queries, query complexity, query size, any applicable features associated with queries per business unit, or a combination thereof.

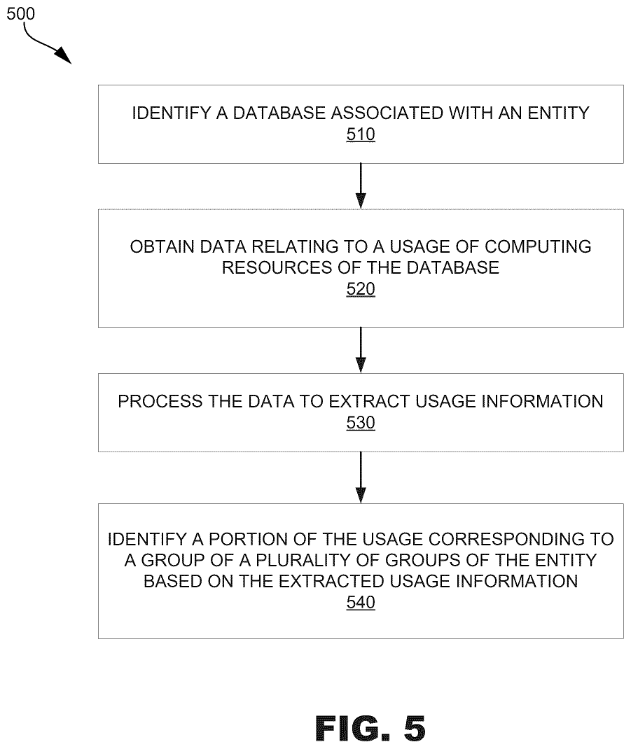

FIG. 5 illustrates a flowchart of an example method 500 for allocating computing resource usage to the respective group of an entity, according to some examples of the present disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to FIG. 2. However, method 500 is not limited to that example.

At step 510, method 500 includes identifying a database associated with an entity (e.g., an organization, a business entity, etc.). For example, an organization may host and run its database on a cloud platform, which is provided by a cloud service provider. The cloud usage management system 110 may identify the database associated with the organization to track, monitor, and optimize the cloud resource usage and costs across the cloud environment.

At step 520, method 500 includes obtaining data relating to a usage of computing resources of the database (e.g., usage data 202), which provide information about how cloud resources and services are used within an organization. Non-limiting examples of the usage data 202 can include organizational data comprising compute resource usage, network usage, cost data, user and access activity, service usage, performance metrics, mappings and relationships of components, services, or applications, metadata comprising clustering history data, organizational history data, task data, or a combination thereof. Leveraging usage data that includes a variety of information associated with the usage, organization, and resources can provide various technical benefits. For example, understanding the relationships between different components can help accurately identify resource consumption for different groups or components within the organization and better understand resource consumption and control costs.

At step 530, method 500 includes processing the data to extract usage information. For example, cloud usage management system 110 can process usage data 202 to extract usage information to understand the resource usage by different groups within the organization and correlate the usage of resources or datasets with a responsible party.

In some cases, processing the data to extract the usage information can include analyzing queries generated by the plurality of groups of the entity. For example, cloud usage management system 110 can analyze queries associated with the organization to determine, per business unit/team of the organization, total number or percentage of queries, total execution, total time, a number of failed queries, compile time, query complexity (e.g., high, moderate, low), query size (e.g., large, medium, small) and so on. In some implementations, processing the data to extract the usage information can include analyzing data tags to correlate the usage of computing resources of the database to each of the plurality of groups.

At step 540, method 500 includes identifying a portion of the usage corresponding to a group of a plurality of groups of the entity based on the extracted usage information. In some examples, method 500 includes allocating the usage of computing resources of the database to each of the plurality of groups based on the extracted usage information. As follows, the disclosed technology can improve and optimize computing resource usage and cloud data management by allocating the usage to appropriate stakeholder(s) associated with the data. Also, the usage allocation and cost allocation per business unit or application can provide further technical benefits such as optimization of resources, budgeting, and forecasting. For example, organizations can, based on the allocation of resource usage and cost, estimate the growth of the cloud use (e.g., data management software use) and predict its future cost such that finance can be planned effectively. Further, organizations can identify wasted utilization of computing resources and redress any inefficiencies and waste.

In some examples, method 500 includes generating a recommendation to reduce the usage of resources in the database. For example, cloud usage management system 110 or optimization module 206 can generate recommendations 216, which may include right-sizing virtual warehouses (e.g., reducing the number of duplicate warehouses, identifying warehouses that are not fully utilized). The recommendations to adjust the size of warehouses can provide numerous technical benefits. Specifically, the efficiency of cloud management and computing resource usage can be improved by load balancing while minimizing spending and maximizing the return. Further, the recommendations may include identifying cloud waste or inefficiencies, which can help organizations use the appropriate size of warehouses, thereby improving compute performance.

In some implementations, recommendations can include identifying a point of time to run a query based on the extracted usage information. For example, cloud usage management system 110 can identify a suitable point of time for running a query in a database. As follows, resource-intensive jobs can be scheduled to be performed during off-peak hours. This can provide technical benefits such as improving the query performance by reducing execution time and optimizing the resource usage by consuming less amount of spend.

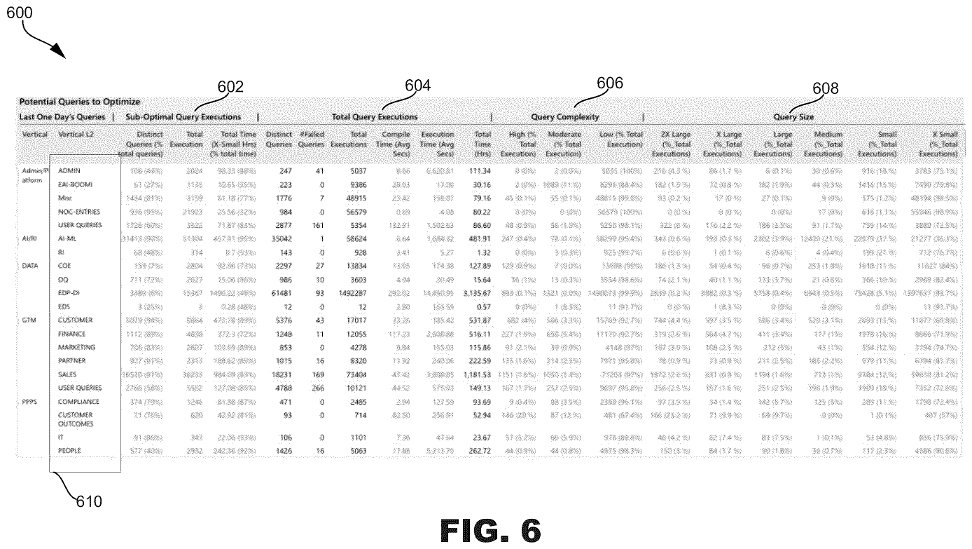

FIG. 6 illustrates an example diagram of an interface 600 of a cloud usage management system, according to some examples of the present disclosure. In this example, interface 600 shows usage and cost allocation based on query analysis. For example, cloud usage management system 110 can analyze historical queries and identify a usage pattern, a design architecture, wasted resources, a responsible party for the usage, etc., for example by correlating the resource usage to a specific responsible party within the organization.

As shown, cloud usage management system 110 may determine sub-optimal query executions 602 (e.g., distinct queries, total execution, total time, etc.), total query executions 604 (e.g., distinct queries, a number of failed queries, total executions, compile time, execution time, total time, etc.), query complexity 606 (e.g., high, moderate, low), and query size 608 (e.g., 2X large, X large, large, medium, small, X small) for each business units/teams 610 (e.g., admin, AI-ML, customer, finance, marketing, sales, compliance, etc.). Based on the comprehensive analysis of queries as shown, cloud usage management system 110 can allocate resource usage to a responsible party (e.g., business unit, business application, etc.,) and allocate costs/spend to the respective party accordingly.

The disclosure now turns to a further discussion of example software models and devices that can be used to implement the technologies described herein.

FIG. 7 is a diagram illustrating an example of a deep learning neural network 700 that can be used to implement all or a portion of the systems and techniques described herein, according to some examples of the present disclosure. For example, the neural network 700 can be used to implement software model(s) 210 of cloud usage management system 110 and/or any other software model(s) described herein (and/or component thereof).

An input layer 720 can be configured to receive data such as data included in cloud usage management system 110 and/or any other data described herein. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as a transformer, autoencoder, Deep Belief Net (DBN), Recurrent Neural Network (RNN), an encoder and/or decoder network, among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

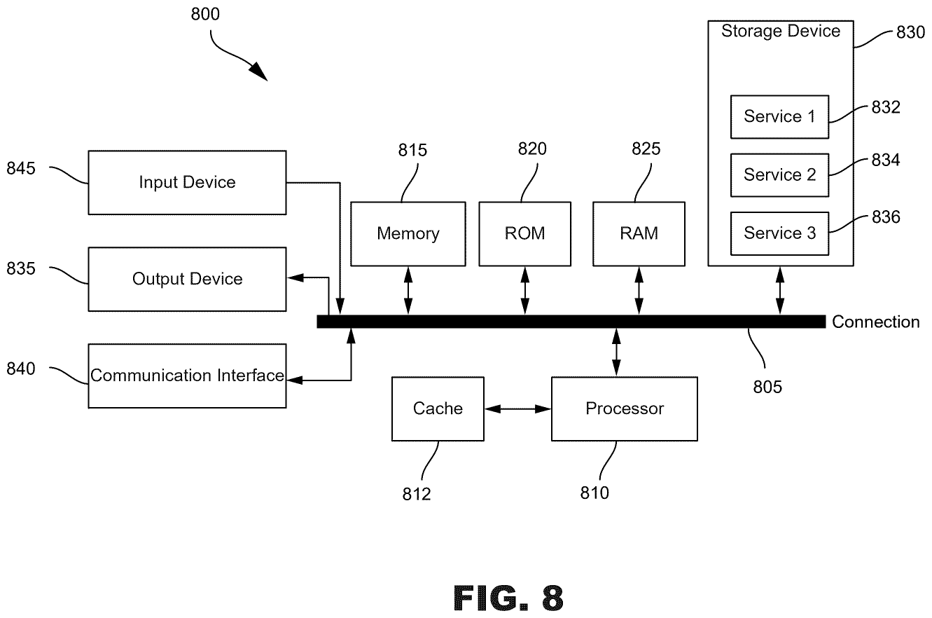

FIG. 8 illustrates an example processor-based system with which some examples of the subject technology can be implemented. For example, processor-based system 800 can be any computing device making up cloud usage management system 110, any of the client devices 116, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some implementations, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communication interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the present disclosure include:

Aspect 1. A computer-implemented method comprising: obtaining usage data associated with a service, wherein the service implements a database including a plurality of datasets; generating a first group vector associated with the service, wherein the first group vector includes a first group identifier and a first usage level associated with the first group identifier; generating a second group vector associated with the service, wherein the second group vector includes a second group identifier and a second usage level associated with the second group identifier; and determining, based on the usage data, the first group vector, and the second group vector, a resource allocation value that characterizes respective usage of the service associated with the first group identifier and the second group identifier.

Aspect 2. The method of Aspect 1, further comprising: allocating, to the first group identifier and the second group identifier, respective resources associated with the service based on the resource allocation value.

Aspect 3. The method of any of Aspects 1 to 2, wherein the first usage level indicates a first usage duration of the service by the first group identifier over a period of time, and the second usage level indicates a second usage duration of the service by the second group identifier over the period of time.

Aspect 4. The method of Aspect 3, further comprising: determining the first usage duration based on a number of queries associated with the first group identifier; and determining the second usage duration based on a number of queries associated with the second group identifier.

Aspect 5. The method of any of Aspects 1 to 4, wherein the first group identifier indicates a first group of an enterprise, and the second group identifier indicates a second group of the enterprise different from the first group.

Aspect 6. A system comprising: one or more processors; and at least one computer-readable storage medium having stored therein instructions which, when executed by the one or more processors, cause the one or more processors to: obtaining usage data associated with a service, wherein the service implements a database including a plurality of datasets; generating a first group vector associated with the service, wherein the first group vector includes a first group identifier and a first usage level associated with the first group identifier; generating a second group vector associated with the service, wherein the second group vector includes a second group identifier and a second usage level associated with the second group identifier; and determining, based on the usage data, the first group vector, and the second group vector, a resource allocation value that characterizes respective usage of the service associated with the first group identifier and the second group identifier.

Aspect 7. The system of Aspect 6, wherein the instructions further cause the one or more processors to: allocate, to the first group identifier and the second group identifier, respective resources associated with the service based on the resource allocation value.

Aspect 8. The system of any of Aspects 6 to 7, wherein the first usage level indicates a first usage duration of the service by the first group identifier over a period of time, and the second usage level indicates a second usage duration of the service by the second group identifier over the period of time.

Aspect 9. The system of Aspect 8, wherein the instructions further cause the one or more processors to: determine the first usage duration based on a number of queries associated with the first group identifier; and determine the second usage duration based on a number of queries associated with the second group identifier.

Aspect 10. The system of any of Aspects 6 to 9, wherein the first group identifier indicates a first group of an enterprise, and the second group identifier indicates a second group of the enterprise different from the first group.

Aspect 11. A computer-implemented method comprising: identifying a database associated with an entity; obtaining data relating to a usage of computing resources of the database; processing the data to extract usage information; and identifying a portion of the usage corresponding to a group of a plurality of groups of the entity based on the extracted usage information.

Aspect 12. The method of Aspect 11, further comprising: allocating the usage of computing resources of the database to each of the plurality of groups based on the extracted usage information.

Aspect 13. The method of any of Aspects 11 to 12, wherein processing the data to extract the usage information comprises: analyzing queries generated by the plurality of groups of the entity.

Aspect 14. The method of any of Aspects 11 to 13, wherein processing the data to extract the usage information comprises: analyzing data tags to correlate the usage of computing resources of the database to each of the plurality of groups.

Aspect 15. The method of any of Aspects 11 to 14, wherein the data relating to the usage of computing resources of the database comprises organizational data comprising a mapping of components, services, or applications.

Aspect 16. The method of any of Aspects 11 to 15, wherein the data relating to the usage of computing resources of the database comprises metadata comprising clustering history data, organizational history data, task data, or a combination thereof.

Aspect 17. The method of any of Aspects 11 to 16, further comprising: generating a report including statistics on the usage of the database by each of the plurality of groups of the entity.

Aspect 18. The method of any of Aspects 11 to 17, further comprising: generating a recommendation to reduce the usage of computing resources of the database.

Aspect 19. The method of any of Aspects 11 to 18, further comprising: adjusting a size of a warehouse associated with the database based on the extracted usage information.

Aspect 20. A non-transitory computer-readable medium having instructions stored thereon that, when executed by one or more processors, cause the one or more processors to perform a method according to any of Aspects 1 to 5.

Aspect 21. A system comprising means for performing a method according to any of Aspects 1 to 5.

Aspect 22. A computer-program product having stored thereon instructions which, when executed by one or more processors, cause the one or more processors to perform a method according to any of Aspects 1 to 5.

Aspect 23. A non-transitory computer-readable medium having instructions stored thereon that, when executed by one or more processors, cause the one or more processors to perform a method according to any of Aspects 11 to 20.

Aspect 24. A system comprising means for performing a method according to any of Aspects 11 to 20.

Aspect 25. A computer-program product having stored thereon instructions which, when executed by one or more processors, cause the one or more processors to perform a method according to any of Aspects 11 to 20.

What is claimed is:

1. A computer-implemented method comprising:
obtaining usage data associated with a service, wherein the service implements a database including a plurality of datasets;
generating a first group vector associated with the service, wherein the first group vector includes a first group identifier and a first usage level associated with the first group identifier;
generating a second group vector associated with the service, wherein the second group vector includes a second group identifier and a second usage level associated with the second group identifier; and
determining, based on the usage data, the first group vector, and the second group vector, a resource allocation value that characterizes respective usage of the service associated with the first group identifier and the second group identifier.

2. The method of claim 1, further comprising:
allocating, to the first group identifier and the second group identifier, respective resources associated with the service based on the resource allocation value.

3. The method of claim 1, wherein the first usage level indicates a first usage duration of the service by the first group identifier over a period of time, and the second usage level indicates a second usage duration of the service by the second group identifier over the period of time.

4. The method of claim 3, further comprising:
determining the first usage duration based on a number of queries associated with the first group identifier; and
determining the second usage duration based on a number of queries associated with the second group identifier.

5. The method of claim 1, wherein the first group identifier indicates a first group of an enterprise, and the second group identifier indicates a second group of the enterprise different from the first group.

6. A system comprising:
one or more processors; and
at least one computer-readable storage medium having stored therein instructions which, when executed by the one or more processors, cause the one or more processors to:
obtaining usage data associated with a service, wherein the service implements a database including a plurality of datasets;
generating a first group vector associated with the service, wherein the first group vector includes a first group identifier and a first usage level associated with the first group identifier;
generating a second group vector associated with the service, wherein the second group vector includes a second group identifier and a second usage level associated with the second group identifier; and
determining, based on the usage data, the first group vector, and the second group vector, a resource allocation value that characterizes respective usage of the service associated with the first group identifier and the second group identifier.

7. The system of claim 6, wherein the instructions further cause the one or more processors to:
allocate, to the first group identifier and the second group identifier, respective resources associated with the service based on the resource allocation value.

8. The system of claim 6, wherein the first usage level indicates a first usage duration of the service by the first group identifier over a period of time, and the second usage level indicates a second usage duration of the service by the second group identifier over the period of time.

9. The system of claim 8, wherein the instructions further cause the one or more processors to:
determine the first usage duration based on a number of queries associated with the first group identifier; and
determine the second usage duration based on a number of queries associated with the second group identifier.

10. The system of claim 6, wherein the first group identifier indicates a first group of an enterprise, and the second group identifier indicates a second group of the enterprise different from the first group.

11. A computer-implemented method comprising:
identifying a database associated with an entity;
obtaining data relating to a usage of computing resources of the database;
processing the data to extract usage information; and
identifying a portion of the usage corresponding to a group of a plurality of groups of the entity based on the extracted usage information.

12. The method of claim 11, further comprising:
allocating the usage of computing resources of the database to each of the plurality of groups based on the extracted usage information.

13. The method of claim 11, wherein processing the data to extract the usage information comprises:
analyzing queries generated by the plurality of groups of the entity.

14. The method of claim 11, wherein processing the data to extract the usage information comprises:
analyzing data tags to correlate the usage of computing resources of the database to each of the plurality of groups.

15. The method of claim 11, wherein the data relating to the usage of computing resources of the database comprises organizational data comprising a mapping of components, services, or applications.

16. The method of claim 11, wherein the data relating to the usage of computing resources of the database comprises metadata comprising clustering history data, organizational history data, task data, or a combination thereof.

17. The method of claim 11, further comprising:
generating a report including statistics on the usage of the database by each of the plurality of groups of the entity.

18. The method of claim 11, further comprising:
generating a recommendation to reduce the usage of computing resources of the database.

19. The method of claim 11, further comprising:
adjusting a size of a warehouse associated with the database based on the extracted usage information.

20. The method of claim 11, further comprising:
identifying a point of time to run a query in the database based on the extracted usage information.
